(19) United States
(12) Patent Application Publication
(10) Pub. No.: US 2008/0099583 A1
(43) Pub. Date: May 1, 2008

(54) Fuel Injector with Direct-Controlled Injection Valve Member with Double Seat

(76) Inventor: Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/814,210

(22) PCT Filed: Jan. 17, 2006
(86) PCT No.: PCT/EP06/50237

§ 371 Date: Jul. 18, 2007

(30) Foreign Application Priority Data
Mar. 1, 2005 (DE) 10 2005 009 148.2

(51) Int. Cl. F02M 51/06

(52) U.S. Cl. 239/533.3; 123/472

(57) ABSTRACT

A fuel injector is supplied with fuel under pressure via a high-pressure source and has direct control of an injection valve member by a piezoelectric actuator via a hydraulic booster. The injection valve member of the fuel injector furthermore has a double seat and the injection valve member is provided with two sealing seats which subdivide a nozzle chamber of the fuel injector into three subchambers. When the injection valve member is closed, a first subchamber and a third are in fluidic communication with one another and are supplied with fuel. The second subchamber, which is in communication with injection openings, is conversely fluidically decoupled from the subchambers by the sealing seats. This proposed disposition, with a combination of direct needle control and a double seat of the injection valve member has the advantage that unthrottling of the fuel injector occurs at a very short injection valve member stroke. As a result, even short piezoelectric actuators can in particular be used.

### FIELD OF THE INVENTION

The invention relates to a fuel injector for injecting fuel, delivered to the fuel injector via a high-pressure source, into a combustion chamber of an internal combustion engine. In particular, the invention relates to a fuel injector with a direct-controlled injection valve member with a double seat.

### PRIOR ART

For supplying combustion chambers of self-igniting internal combustion engines with fuel, both pressure-controlled and stroke-controlled injection systems can be used. As the fuel injection systems, not only unit fuel injectors and pump-line-nozzle units but also reservoir injection systems are used. Reservoir injection systems (common rails) advantageously make it possible to adapt the inject pressure to the load and rpm of the engine.

In the prior art, common rail injectors with piezoelectric actuators are known, in which a nozzle needle is controlled by way of the pressure in one or more control chambers. The pressure in this control chamber or in these control chambers is controlled via the piezoelectric actuator and optionally one or more control valves. In such built-in accessories, the nozzle needle is thus indirectly controlled by the piezoelectric actuator.

Besides these indirectly controlled common rail injectors, systems are meanwhile known from the prior art in which a nozzle needle is controlled directly by a piezoelectric actuator. Such injectors have a high opening and closing speed and an at least comparatively simple injector construction. However, such injectors require long piezoelectric actuators in order to attain the necessary nozzle needle stroke.

From German Patent DE 195 19 191 C1, an injection valve for fuel injection systems is known which has a nozzle needle as well as a tappet driving the nozzle needle and also has a piezoelectric trigger device, which is hydraulically boosted via one primary and one secondary piston. Via the secondary piston, the piezoelectric trigger device drives the tappet, which in turn directly controls the nozzle needle. However, the construction described in DE 195 19 191 C1 is comparatively complex, and in particular it has the disadvantage that comparatively long piezoelectric actuators must be used in order to attain the required stroke for the injection event and to unthrottle the nozzle needle.

Alternatively, hydraulic boosters may be used. However, high hydraulic ratios between the actuator stroke and the nozzle needle stroke are usually necessary along with the use of long mechanical connecting parts. These injectors therefore as a rule have a poorer, indirect transmission behavior of the switching force of the actuator to the nozzle needle.

### ADVANTAGES OF THE INVENTION

Particularly to reduce the requisite actuator length, an injection valve member is needed which for complete opening of the injection openings needs to traverse only a short stroke. This can be achieved with an injection valve member with a double seat and fuel supply via both sealing seats. The nucleus of the invention resides in combining this kind of double seat of the injection valve member, where fuel is supplied to the injection openings via both sealing seats, with direct triggering of the injection valve member by a piezoelectric actuator, so as to achieve an optimized injector design in this way. For this purpose, a fuel injector is proposed for injecting fuel, delivered under pressure to the fuel injector via a high-pressure source, into a combustion chamber of an internal combustion engine. This fuel injector has an injector housing, a high-pressure chamber, a pressure chamber, a nozzle chamber, an electrically triggerable linear actuator located in the high-pressure chamber, and an injection valve member coupled to the linear actuator via a coupling. The pressure chamber and the high-pressure chamber are in fluidic communication with one another, as are the nozzle chamber and the pressure chamber. The injection valve member is guided linearly in at least one guide portion, so that the injection valve member can execute an opening and a closing motion parallel and antiparallel to a closing direction. The injection valve member has at least two sealing seats, such that in a closed position, the sealing seats rest on at least one wall of the nozzle chamber. The nozzle chamber is subdivided into at least three subchambers, and a first subchamber in the closing direction and a third subchamber in the closing direction are each in fluidic communication with the pressure chamber. A second subchamber, disposed in the closing direction between the first subchamber and the third subchamber, is fluidically decoupled from the first subchamber and from the third subchamber and is fluidic communication with at least one injection opening for injecting fuel into the combustion chamber.

The actuator may for instance be a piezoelectric actuator, but still other actuator designs, such as magnet actuators, can also be used. The coupling may for instance be a hydraulic coupling. This hydraulic coupling can additionally have a hydraulic booster as well, particularly for converting a stroke of the actuator into a stroke of the injection valve member. This too is meant to be understood, within the scope of the present invention, as “direct needle control”. It has proved especially advantageous in this respect if this booster has a step-up ratio in the range from 0.5 to 2, preferably in the range from 1.0 to 1.5, and especially preferably 1.0. The term step-up ratio is understood to be the ratio of an injection valve member stroke to the stroke of the actuator.

The hydraulic coupling can be effected for instance via a coupling chamber, which in particular is filled with a hydraulic fluid (preferably fuel) and which may be defined for instance by a first coupler piston, connected to the actuator, and by a second coupler piston, connected to the injection valve member, as well as by at least one sealing sleeve. The sealing sleeve may be connected to the first and/or the second coupler piston via at least one spring. It has proved to be especially advantageous if the at least one coupling chamber has a first coupling chamber and a second coupling chamber, which are fluidically in communication with one another via at least one connecting conduit. It is especially advantageous if this at least one connecting conduit has at least one throttle element, at which the at least one connecting conduit is narrowed in its cross section. The coupling chambers may for instance be divided via a partition connected to the injector housing; both a rigid connection and a flexible connection may be used. Moreover, the at least one sealing sleeve may also have two individual sealing sleeves; the first sealing sleeve is connected to the first coupler piston via a first spring, and the second sealing sleeve is connected to the second coupler piston via a second spring, and the first sealing sleeve and the second sealing sleeve are each connected to the partition. Alternatively, the first sealing sleeve could be connected to the first coupler piston and the second sealing sleeve could be connected to the second coupler piston, and both sealing sleeves could be braced on the partition via a respective spring. A construction in which each sealing sleeve is braced on the respective coupler piston by a spring and on the partition by a second spring is also conceivable.

The fluidic communication between the pressure chamber and the nozzle chamber and between the pressure chamber and the first subchamber and/or the second subchamber may be accomplished for instance via at least one flow conduit let into the injection valve member. In particular, it is advantageous to use a flow conduit in the form of a groove let into an injection valve member, or a plurality of such grooves.

Because of the fuel injector of the invention, the required actuator length for direct needle control is reduced greatly. Moreover, no travel boosting or only slight travel boosting between the actuator and the injection valve member is necessary for achieving the requisite injection valve member stroke. A design of the hydraulic coupling with a stroke step-up ratio of approximately one is possible. The result is a very stiff transmission behavior of the actuator control forces on the injection valve member, and optimal control precision of the injection valve member is thus achieved. This kind of injector design permits precise metering of small quantities of fuel. Because of the great stiffness of the transmission and the fast needle motion, a sturdy design in which manufacturing tolerances have little influence is achieved.

### DRAWINGS

The invention is described below in further detail in conjunction with the drawings.

Shown are:

FIG. 1, a first exemplary embodiment of a fuel injector with an injection valve member and a double seat and with direct control of the injection valve member via an actuator and a hydraulic booster;

FIG. 2, a second exemplary embodiment of a fuel injector with an injection valve member and a double seat and with direct control of the injection valve member with a simple coupling chamber; and

FIG. 3, a third exemplary embodiment, as an alternative to FIG. 2, with a simple coupling chamber and a sealing sleeve guided on a single coupler piston.

### EXEMPLARY EMBODIMENTS

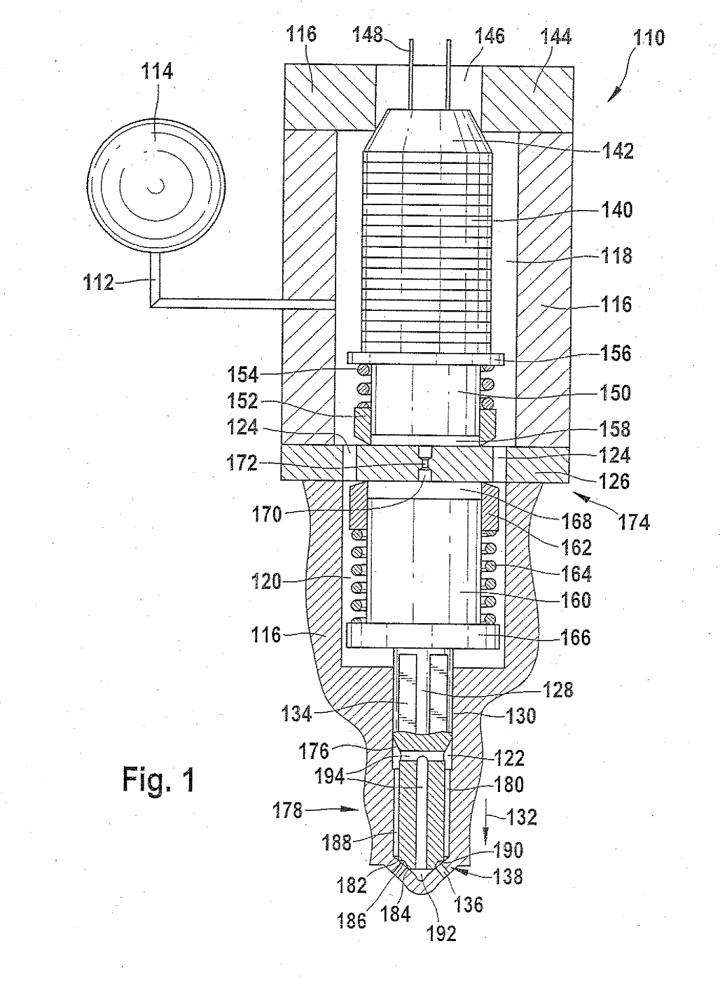

FIG. 1 shows a first, preferred exemplary embodiment of a fuel injector 110 for injecting fuel into a combustion chamber of an internal combustion engine. The fuel injector 110 communicates via a high-pressure line 112 with a pressure reservoir (common rail) 114. The fuel injector 110 also has an injector housing 116. The injector housing 116 has a high-pressure chamber 118, which is in communication with the pressure reservoir 114 via the high-pressure line 112 and is supplied with fuel that is under pressure. The injector housing 116 also has both a pressure chamber 120 and a nozzle chamber 122. The pressure chamber 120 is in communication with the high-pressure chamber 118 via fuel conduits 124, which are let into a partition 126 that divides the pressure chamber 120 from the high-pressure chamber 118. The fuel conduits 124 are embodied in this exemplary embodiment as cylindrical bores, which are made in the partition 126. Other designs of the fuel conduits are also conceivable.

An injection valve member 128 is introduced into the pressure chamber 120 and the nozzle chamber 122 and is guided in the nozzle chamber 122 along a guide portion 130. The injection valve member 128 can thus move parallel or antiparallel to a closing direction 132 of the fuel injector 110. In the guide portion 130 of the injection valve member 128, flow conduits 134 are provided, in the form of flat faces let into the injection valve member 128. Still other designs of the flow conduits 134 are conceivable, such as bores and so forth. These flow conduits 134 extend vertically, and in this exemplary embodiment they are distributed uniformly along the circumference of the injection valve member 128. The flow conduits 134 have the effect that despite the guidance of the injection valve member 128 in the guide portion 130, the nozzle chamber 122 is in fluidic communication with the pressure chamber 120 of the fuel injector 110. In this way, fuel from the high-pressure chamber 118 can flow through the pressure chamber 120 in the closing direction 132 to one or a plurality of injection openings 136, which are let into the wall of a conically tapering region 138 of the nozzle chamber 122 in the lower region of the fuel injector 110. The design of these injection openings 136 is known from the prior art and can vary in their design, number and disposition, depending on the internal combustion engine involved.

In this exemplary embodiment, a piezoelectric actuator 140 is introduced into the high-pressure chamber 118 and is capable of expanding and contracting in the closing direction 132 of the injection valve member 128. The piezoelectric actuator 140 is sealed off on its surface by suitable sealing from the ambient medium (fuel), so that the functionality of the piezoelectric actuator 140 will not be impaired by the fuel. The piezoelectric actuator 140 is braced on its top side via a sealing element 142 against an upper wall 144 of the injector housing 116. An opening 146 is made in the upper wall 144, and by way of it electrical contacts 148 for triggering the piezoelectric actuator 140 are led out of the injector housing 116. The opening 146 can be sealed tightly, once the electrical contacts 148 have been led to the outside, by means of a suitable sealing composition, such as a plastic.

On its lower end, the piezoelectric actuator 140 is connected to a first coupler piston 150. This first coupler piston 150 is surrounded on its lower edge by a first sealing sleeve 152, which is braced via a first spiral spring 154 relative to a protrusion 156 of the first coupler piston 150 and is thus pressed against the partition 126. The first sealing sleeve 152 is annular in shape and rests tightly against the first coupler piston 150. Thus between the first coupler piston 150 and the partition 126, a first coupling chamber 158 is formed, which is defined by the partition 126, the first coupler piston 150, and the sealing sleeve 152. The first sealing sleeve 152 is shaped such that it tapers to a point at its lower end, so that a sealing edge is formed. The first coupling chamber 158 may for instance be filled with fuel through a suitable gap flow in the guide or through other throttle elements.

The upper end of the injection valve member 128 has a second coupler piston 160. Like the first coupler piston 150, the second coupler piston 160 is also embodied cylindrically. On its upper end, the second coupler piston 160 is surrounded by a second, circular-annular sealing sleeve 162, whose edge tapers to a point as well but toward the top in this exemplary embodiment. Still other designs of the sealing sleeves 152, 162 are conceivable. The second sealing sleeve 162 is braced by a second spiral spring 164 on a protrusion 166 of the second coupler piston 160 and as a result is pressed against the partition 126. The sealing sleeve 162, the upper face of the second coupler piston 160, and the partition 126 define a second coupling chamber 168. Once again, this second coupling chamber 168 can be filled with fuel, for instance via a gap flow or other throttle elements.

A connecting conduit 170 is also let into the partition 126, and by way of it fuel can flow out of the first coupling chamber 158 into the second coupling chamber 168 and vice versa. The connecting conduit 170 essentially has the shape of a cylindrical bore. Still other designs are conceivable, such as a plurality of bores, or a nonlinear course of the connecting conduit 170. Preferably approximately in the center, the connecting conduit 170 has a throttle element 172 in the form of a constriction that is defined spatially relative to the length of the connecting conduit 170. Still other designs of the throttle element 172 are conceivable.

The two coupling chambers 158 and 168 achieve a hydraulic force transmission between the first coupler piston 150 (and thus the piezoelectric actuator 140) and the injection valve member 128. As a result of this hydraulic force transmission, a compensation for temperature expansions and manufacturing tolerances of the components is attained in particular. At the same time by this hydraulic coupling, a travel-force transmission can be achieved between the piezoelectric actuator 140 and the injection valve member 128.

In the state of repose, the same pressure prevails in both coupling chambers 158 and 168 as in the high-pressure chamber 118, or in other words approximately the pressure of the pressure reservoir 114 (rail pressure). The injection valve member 128 is then closed. The piezoelectric actuator 140 is electrically charged in the state of repose and thus has its maximum lengthwise expansion. For triggering the fuel injector 110, the piezoelectric actuator 140 is discharged, and as a result the piezoelectric actuator 140 becomes shorter, and the first coupler piston 150 is moved counter to the closing direction 132. As a result, the pressure in the first coupling chamber 158 drops. For pressure equalization, fuel flows out of the second coupling chamber 168 into the first coupling chamber 158 through the connecting conduit 170, as a result of which in turn an underpressure briefly occurs in the second coupling chamber 168. This underpressure is compensated for in that the second coupler piston 160, and thus the entire injection valve member 128, is moved upward, or in other words counter to the closing direction 132. As a result, an opening event of the injection valve member 128 is initiated. For closing the injection valve member 128, the piezoelectric actuator 140 is electrically charged again and in the process expands again (in the closing direction 132). As a result, an overpressure briefly occurs in the first coupling chamber 158, which is compensated for by the fact that fuel flows through the connecting conduit 170 into the second coupling chamber 168, and as a result in turn a pressure is exerted on the second coupler piston 160. Thus the injection valve member 128 closes, because it executes a motion in the closing direction 132.

The apparatus shown in FIG. 1 having the two coupling chambers 158 and 168 acts not only as a means of hydraulic force transmission but also can act as a hydraulic booster 174 for converting a stroke of the piezoelectric actuator 140 into a stroke of the injection valve member 128. This hydraulic booster 174 in this exemplary embodiment is thus composed of the first coupler piston 150, the first coupling chamber 158, the connecting conduit 170, the second coupling chamber 168, and the second coupler piston 160. The step-up ratio of the hydraulic booster 174 is the result of the ratio of the hydraulic areas of the coupler pistons 150 and 160, or in other words the area of the end face, oriented toward the first coupling chamber 158, of the first coupler piston 150 and the end face, oriented toward the second coupling chamber 168, of the second coupler piston 160. In this way, by means for instance of a reduced hydraulic area of the second coupler piston 160 in comparison with the hydraulic area of the first coupler piston 150, a stroke boost can be brought about with a step-up ratio greater than one, and as a result even with a short stroke of the piezoelectric actuator 140, a greater stroke of the injection valve member 128 can be accomplished. As a result, the structural length of the piezoelectric actuator 140 can be shortened. Even with an area ratio of one, that is, a 1:1 stroke boost, the fuel injector 11 shown can be operated, and the hydraulic booster 174 can in this case advantageously be used, as described above, to compensate for temperature expansions and manufacturing tolerances.

The injection valve member 128, besides the second coupler piston 160 described, has a guide portion 130, adjoining the coupler piston 160 downward in the closing direction 132, and the guide portion is followed by a conical portion 176 and a cylindrical front portion 178. The cylindrical front portion 178 of the injection valve member 128 has a lesser diameter than the nozzle chamber 122, so that an annular gap 180 is created between the front portion 178 and the wall of the nozzle chamber 122. Fuel which flows out of the pressure chamber 120 via the flow conduits 134 in the guide portion 130 of the injection valve member 128 can flow through this annular gap 180 in the closing direction 132 of the injection valve member 128, in the direction of the injection openings 136.

The injection valve member 128, in its front portion 178, moreover has two sealing seats 182, 184 on its lower end. These sealing seats 182, 184 are embodied as encompassing circular edges of a constriction 186 in the region of the tip of the injection valve member 128. In the closed state of the injection valve member 128, or in other words when the injection valve member 128 is located in its lowermost position with respect to the closing direction 132, the sealing seats 182, 184 rest firmly against the inner wall of the conically tapering region 138 of the nozzle chamber 122. The sealing seats 182, 184 are designed such that when the tip of the injection valve member 128 is in contact with the inner wall of the conically tapering region 138 of the nozzle chamber 122, they form an annular hollow chamber (second subchamber 190; see below) in the region of the annular constriction 186. The injection openings 136 are disposed in the region of this annular hollow chamber in the wall of the conically tapering region 138. The sealing seats 182, 184 accordingly subdivide the nozzle chamber 122 into three subchambers 188, 190, 192: a first subchamber 188, which is disposed in the closing direction 132 above the sealing seat 182; a second subchamber 190, which is disposed between the two sealing seats 182 and 184; and a third subchamber 192, which is disposed below the sealing seat 184, in a region which is not completely filled by the front portion 178 of the injection valve member 128.

In the region of the front portion 178 of the injection valve member 128, flow conduits 194 are let into the injection valve member 128, for instance in the form of central bores in the injection valve member 128. Via these flow conduits 194, fuel can flow from the first subchamber 188 into the third subchamber 192, so that both subchambers 188, 192 are in fluidic communication with one another, and the same fuel pressure prevails in these subchambers 188, 192.

In the closed state of the injection valve member 128, the injection openings 136 are sealed off by the two sealing seats 182, 184 of the injection valve member 128. Upon opening of the injection valve member 128, that is, upon a motion counter to the closing direction 132, two sealing seats 182, 184 are thus essentially simultaneously opened. These sealing seats 182, 184 furthermore advantageously have a large diameter, that is, a diameter which is as close as possible to the diameter of the first subchamber 188. As a result of this design, unthrottling of the fuel injector (and hence the onset of an injection event) is already achieved at a short injection valve member stroke, for instance a stroke of the injection valve member 128 of 40 μm. Such a short stroke can already be furnished by very short piezoelectric actuators 140, of the kind currently in mass production. Typical piezoelectric actuators 140 have actuator lengths of approximately 35 mm and a stroke of approximately 45 micrometers. The construction described allows the hydraulic booster 174 already to be designed with a very low hydraulic boost, in particular with a step-up ratio of between 0.5 and 2, and advantageously in the range of one. A rigid transmission behavior between the piezoelectric actuator 140 and the injection valve member 128 is thus attained, and as a result the switching properties of the fuel injector 110 are greatly improved. In particular, the exact metering of very tiny preinjection quantities is made possible. Moreover, the exemplary embodiment described is very sturdy with regard to manufacturing tolerances.

By the optional use of the throttle element 172 between the first coupling chamber 158 and the second coupling chamber 168, the opening characteristic of the injection valve member 128 can be optimized further. By damping the opening speed of the injection valve member 128 by suitable adjustment of the throttle element 172, an optimized least-quantity capability and an advantageous injection rate course can be attained.

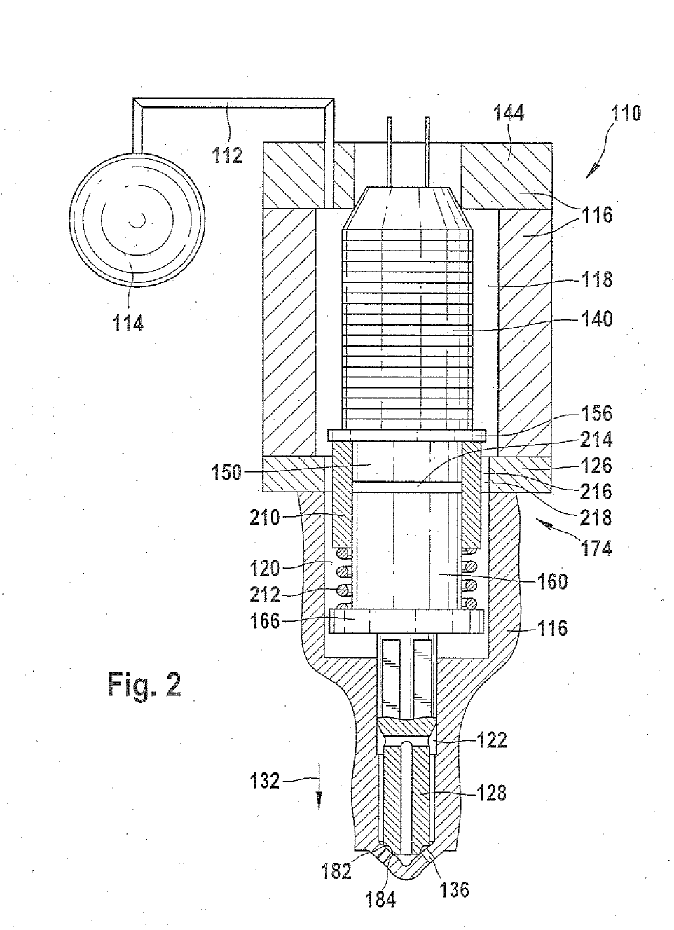

If a step-up ratio of the hydraulic booster 174 of one is employed, equal hydraulic areas are obtained for the first coupler piston 150 and the second coupler piston 160, and in particular (given a cylindrical design) equal diameters of these pistons 150, 160. As a result, the structural makeup can be simplified. FIG. 2 schematically shows an exemplary embodiment accordingly, with a modified construction of the hydraulic booster 174.

Once again, the fuel injector 110 in the exemplary embodiment of FIG. 2 has an injector housing 116 with a high-pressure chamber 118, a pressure chamber 120, and a nozzle chamber 122. The design of the injection valve member 128 is analogous to the design of the injection valve member 128 of the exemplary embodiment in FIG. 1. The function of fuel delivery to the injection openings 136, and in particular the design of the injection valve member 128 with two sealing seats 182 and 184 and with the subchambers 188, 190, 192, is identical and functionally identical to FIG. 1.

The exemplary embodiment of FIG. 2 differs from the exemplary embodiment of FIG. 1 only in the design of the hydraulic booster 174. Once again, the piezoelectric actuator 140 is connected on its lower end, in terms of the closing direction 132, to a first coupler piston 150, which again has a protrusion 156. The injection valve member 128 also again has a second coupler piston 160 on its upper end. In this exemplary embodiment, the first coupler piston 150 and the second coupler piston 160, however, are both surrounded by a single sealing sleeve 210, which is braced on its upper end on the protrusion 156 of the first coupler piston 150. On the lower end, the sealing sleeve 210 is braced on the protrusion 166 of the second coupler piston 160 via a spiral spring 212. Thus a coupling chamber 214 is created, defined by the first coupler piston 150, the second coupler piston 160, and the sealing sleeve 210. The partition 126 in this exemplary embodiment does not communicate with the coupling chamber 214 but instead has a cylindrical bore 216, through which the sealing sleeve 210 is guided. Thus between the sealing sleeve 210 and the partition 126, an annular gap 218 is formed, by way of which fuel can flow out of the high-pressure chamber 118 into the pressure chamber 120. The exemplary embodiment shown in FIG. 2 has the advantage in particular that, compared to the exemplary embodiment in FIG. 1, the number of components is reduced considerably. Alternatively to the exemplary embodiment shown in FIG. 2, the sealing sleeve 210 may also be designed as an integral component of the first coupler piston 150. Alternatively, the sealing sleeve 210 may be designed as an integral component of the second coupler piston 160, in which case the sealing sleeve 210 would be braced on its upper end by means of the spring 212 against the protrusion 156 of the first coupler piston 150. Alternatively, two spiral springs 210 may also be used, with the sealing sleeve 210 then braced both against the protrusion 166 of the second coupler piston 160 and against the protrusion 156 of the first coupler piston 150. To achieve minimal volumes in the coupling chamber, however, a two-part version with a separate sealing sleeve 210, as shown in FIG. 2, is advantageous. A minimal volume in the coupling chamber improves the force transmission and minimizes losses.

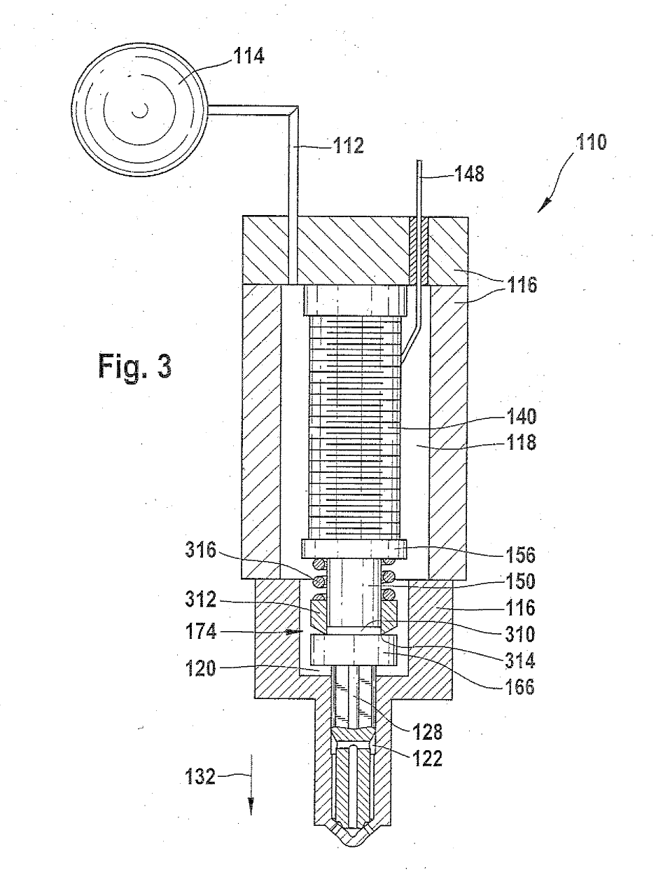

In FIG. 3, a third exemplary embodiment of a fuel injector 110 is shown, which is an alternative to the version of FIG. 2. The injection valve member 128 and the functionality of the sealing seats 182, 184 are designed here analogously to the version of FIG. 2. This exemplary embodiment again has a coupling chamber 310 for force transmission between the piezoelectric actuator 140 and the injection valve member 128. The coupling chamber 310 is again surrounded by a sealing sleeve 312. The version of FIG. 3 differs from the version of FIG. 2 essentially in the guidance of the sealing sleeve 312: The coupling in FIG. 3 has only one coupler piston 150, on which the sealing sleeve 312 is guided. Guidance of the sealing sleeve 312 by a second coupler piston (analogous to the coupler piston 160 of FIG. 2) has been dispensed with here. The sealing sleeve 312 is provided on its lower end (that is, pointing toward the injection valve member 128) with a sealing edge 314 and is braced directly on the protrusion 166 of the injection valve member 128. A spring element 316, which is braced on its upper end on the protrusion 156 of the coupler piston 150 that is connected to the piezoelectric actuator 140, urges the sealing sleeve 312 with a force in the closing direction 132.

In this exemplary embodiment of FIG. 3, the second coupler piston 160 connected to the injection valve member 128 has been dispensed with, and the sealing sleeve 312 is guided only on the first coupler piston 150, connected to the piezoelectric actuator 140. Alternatively, the coupler piston 150 could also be dispensed with, and guidance of the sealing sleeve 312 could be done on the coupler piston 160. These embodiments, in which the sealing sleeve 312 is effected, are especially advantageous, since tensions between the piezoelectric actuator 140 and the injection valve member 128 which could occur from manufacturing inaccuracies in the case of a multi-part injector body are avoided. Moreover, a simple structural makeup with a low number of parts is obtained.

In the exemplary embodiments of FIGS. 2 and 3, the coupling chamber 214, 310 accomplishes only compensation for manufacturing tolerances. Because of the simple construction with only one coupling chamber 214, 310, there is as a rule always a direct force transmission between the piezoelectric actuator 140 and the injection valve member 128 with a step-up ratio of 1.

### LIST OF REFERENCE NUMERALS

110 Fuel injector
112 High-pressure line
114 Pressure reservoir
116 Injector housing
118 High-pressure chamber
120 Pressure chamber
122 Nozzle chamber
124 Fuel conduits
126 Partition
128 Injection valve member
130 Guide portion
132 Closing direction
134 Flow conduits
136 Injection openings
138 Conically tapering region of the nozzle chamber
140 Piezoelectric actuator
142 Sealing element
144 Upper wall of the injector housing
146 Opening
148 Electrical contacts
150 First coupler piston
152 First sealing sleeve
154 First spiral spring
156 Protrusion
158 First coupling chamber
160 Second coupler piston
162 Second sealing sleeve
164 Second spiral spring
166 Protrusion
168 Second coupling chamber
170 Connecting conduit
172 Throttle element
174
176 Conical portion
178 Front portion
180 Annular gap
182 Sealing seat
184 Sealing seat
186 Annular constriction
188 First subchamber
190 Second subchamber
192 Third subchamber
194 Flow conduits
210 Sealing sleeve
212 Spiral spring
214 Coupling chamber
216 Cylindrical bore
218 Annular gap
310 Coupling chamber
312 Sealing sleeve
314 Sealing edge
316 Spring element

1-13. (canceled)

14. A fuel injector for injecting fuel, supplied via a high-pressure source under pressure to the fuel injector, into a combustion chamber of an internal combustion engine, the fuel injector comprising an injector housing, a high-pressure chambers a pressure chamber, the pressure chamber and the high-pressure chamber being in fluidic communication, a nozzle chamber, the nozzle chamber and the pressure chamber being in fluidic communication, an electrically triggerable linear actuator received in the high-pressure chamber, and an injection valve member coupled with the linear actuator via a coupling,
the injection valve member being guided linearly in at least one guide portion in such a way that the injection valve member can execute a closing motion in a closing direction and an opening motion opposite to the closing direction;
the injection valve member having at least two sealing seats disposed in such a manner that in a closed position, the sealing seats rest on at least one wall of the nozzle chamber, as a result of which the nozzle chamber is subdivided into at least three subchambers of which a first subchamber and a third subchamber spaced from one another in the closing direction are each in fluidic communication with the pressure chamber and a second subchamber disposed between the first subchamber and the third subchamber, is decoupled fluidically from the first subchamber and from the third subchamber and is in fluidic communication with at least one injection opening for injecting fuel into the combustion chamber.

15. The fuel injector as defined by claim 14, wherein the linear actuator comprises a piezoelectric actuator.

16. The fuel injector as defined by claim 14, wherein the coupling comprises a hydraulic coupling.

17. The fuel injector as defined by claim 15, wherein the coupling comprises a hydraulic coupling.

18. The fuel injector as defined by claim 16, wherein the hydraulic coupling comprises a hydraulic booster boosting a pressure and/or for boosting a stroke of the actuator into a stroke of the injection valve member.

19. The fuel injector as defined by claim 17, wherein the hydraulic coupling comprises a hydraulic booster boosting a pressure and/or for boosting a stroke of the actuator into a stroke of the injection valve member.

20. The fuel injector as defined by claim 18, wherein the hydraulic booster has a step-up ratio in the range of from 0.5 to 2, preferably in the range of from 1.0 to 1.5, and especially preferably has a step-up ratio of 1.0.

21. The fuel injector as defined by claim 19, wherein the hydraulic booster has a step-up ratio in the range of from 0.5 to 2, preferably in the range of from 1.0 to 1.5, and especially preferably has a step-up ratio of 1.0.

22. The fuel injector as defined by claim 16, wherein the hydraulic coupling comprises at least one coupling chamber essentially defined by at least one sealing sleeve and at least two of the following elements: a first coupler piston connected to the actuator a second coupler piston in communication with the injection valve member and/or the injection valve member.

23. The fuel injector as defined by claim 18, wherein the hydraulic coupling comprises at least one coupling chamber essentially defined by at least one sealing sleeve and at least two of the following elements: a first coupler piston connected to the actuator a second coupler piston in communication with the injection valve member and/or the injection valve member.

24. The fuel injector as defined by claim 19, wherein the hydraulic coupling comprises at least one coupling chamber essentially defined by at least one sealing sleeve and at least two of the following elements: a first coupler piston connected to the actuator a second coupler piston in communication with the injection valve member and/or the injection valve member.

25. The fuel injector as defined by claim 22, wherein the at least one sealing sleeve is connected via at least one spring to the first coupler piston and/or the second coupler piston.

26. The fuel injector as defined by claim 25, wherein the at least one coupling chamber comprises a first coupling chamber and a second coupling chamber and the first coupling chamber and the second coupling chamber being in fluidic communication via at least one connecting conduit.

27. The fuel injector as defined by claim 26, wherein the at least one connecting conduit comprises at least one throttle element and wherein the at least one connecting conduit is narrowed in its cross section at the least one throttle element.

28. The fuel injector as defined by claim 26, wherein the first coupling chamber and the second coupling chamber are separated via a partition connected to the injector housing, and wherein the partition comprising at least one connecting conduit.

29. The fuel injector as defined by claim 27, wherein the first coupling chamber and the second coupling chamber are separated via a partition connected to the injector housing, and wherein the partition comprising at least one connecting conduit.

30. The fuel injector as defined by claim 28, wherein the at least one sealing sleeve comprises at least one first sealing sleeve and at least one second sealing sleeve, wherein the first sealing sleeve is connected to the first coupler piston via a first spring and the second sealing sleeve is connected to the second coupler piston via a second spring, and wherein the first sealing sleeve and the second sealing sleeve are connected to the partition.

31. The fuel injector as defined by claim 29, wherein the at least one sealing sleeve comprises at least one first sealing sleeve and at least one second sealing sleeve, wherein the first sealing sleeve is connected to the first coupler piston via a first spring and the second sealing sleeve is connected to the second coupler piston via a second spring, and wherein the first sealing sleeve and the second sealing sleeve are connected to the partition.

32. The fuel injector as defined by claim 14, further comprising at least one flow conduit let into the injection valve member providing the hydraulic communication between the pressure chamber and the nozzle chamber and between the pressure chamber and the first subchamber and/or third subchamber.

33. The fuel injector as defined by claim 22, wherein the at least one coupling chamber is defined by the first coupler piston connected to the actual, by the injection valve member, and by a sealing sleeve, and wherein the sealing sleeve is guided on the first coupler piston and is braced in sealing fashion against the injection valve member.
